(19) United States
(12) Patent Application Publication
(10) Pub. No.: US 2025/0353309 A1
(43) Pub. Date: Nov. 20, 2025

(54) INK STORAGE CONTAINER AND INK EJECTION DEVICE

(71) Applicant: CANON KABUSHIKI KAISHA, Tokyo (JP)

(72) Inventors: NARUYUKI NOJO, Kanagawa (JP); HIROAKI KUSANO, Tokyo (JP); JUNICHIRO IRI, Kanagawa (JP); TAKANOBU MANABE, Kanagawa (JP); MITSURU CHIDA, Kanagawa (JP)

(21) Appl. No.: 19/205,922

(22) Filed: May 12, 2025

(30) Foreign Application Priority Data
May 14, 2024 (JP) 2024-078843
Mar. 4, 2025 (JP) 2025-034081

(51) Int. Cl. B41J 2/175

(52) U.S. Cl. CPC B41J 2/17553; B41J 2/17513; B41J 2/17523; B41J 2/17596; B41J 2002/17516

(57) ABSTRACT

An ink storage container detachably mounted to an apparatus main body of an ink ejection apparatus includes a flexible inner bag configured to store ink, a flexible outer bag configured to cover the inner bag, an ink discharge portion configured to discharge ink from the inner bag to the outside thereof, and an air introduction portion configured to introduce air into or discharging air from a space between the inner and outer bags. The technologies have the potential to contribute to achievement of a sustainable society such as a decarbonized society/circular society.

### BACKGROUND

### Field of the Technology

The present disclosure relates to an ink storage container for use in an ink ejection apparatus, and more particularly to an ink storage container configured to store ink, aiming to reduce the amount of plastic used, improve prevention of ink leakage resulting from the reduction, and enhance the complete use of ink supplied to the ink ejection apparatus.

### Description of the Related Art

In the field of recording apparatuses that serve as ink ejection apparatuses (liquid ejection apparatuses) for ejecting ink, as a recording liquid, onto a recording medium to perform recording, it has been known to facilitate ink replenishment due to ink consumption by allowing a user to manually replace an ink storage container that is attachable to and detachable from the apparatus main body. If the ink storage container is accidentally dropped during replacement, ink may leak due to the impact. It may also be difficult to completely use up the ink contained in the ink storage container.

As an attempt to solve this problem, for example, a technology is disclosed in Japanese Patent Application Publication No. 2011-183651. According to Japanese Patent Application Publication No. 2011-183651, to prevent ink leakage, the outside of the ink storage bag is covered and protected by a hard case made of a material such as plastic. The ink storage bag is pressurized by supplying air around the ink storage bag using a device such as a pump, so that the ink is fully supplied to the main body, enabling complete use of the ink in the ink storage container.

### SUMMARY

Here, in recent years, there has been a social demand for development of technologies that can contribute to the achievement of a sustainable society, such as a decarbonized society/circular society. In particular, from the viewpoint of environmental issues, there has been a demand for so-called elimination/reduction of plastic waste, in other words, minimizing the use of plastic materials. The method according to Japanese Patent Application Publication No. 2011-183651 uses a large amount of plastic, and an ink storage container and an inkjet recording apparatus that address these issues must be provided.

The present disclosure is directed to the technology to provide a highly reliable ink storage container while achieving a reduction in the amount of plastic used.

According to some embodiments, an ink storage container attachable to and detachable from an apparatus main body of an ink ejection apparatus according to the present disclosure includes:
a flexible inner bag configured to store ink;
a flexible outer bag configured to cover the inner bag;
an ink discharge portion configured to allow ink stored in the inner bag to be discharged to the outside of the inner bag; and
an air introduction portion configured to introduce air into a space between the inner bag and the outer bag; wherein
the ink discharge portion comprising:
   a discharge path forming member having an ink outlet and an ink discharge path that communicates between an interior of the inner bag and the ink outlet;
   a first sealing member configured to take a first sealing position and a first non-sealing position within the ink discharge path, the first sealing position being a position at which the first sealing member is in contact with a wall surface of the ink discharge path to seal the ink discharge outlet from an interior of the ink discharge path and the first non-sealing position being a position at which the first sealing member is away from the wall surface; and
   a first biasing member configured to apply a biasing force to position the first sealing member at the first sealing position.

According to some embodiments, an ink ejection apparatus according to the present disclosure includes:
the above mentioned ink storage container; and
an apparatus main body to which the ink storage container is detachably mounted;
the apparatus main body comprising:
   a first connecting portion connected to the ink discharge portion;
   a second connecting portion connected to the air introduction portion; and
   an ejection portion configured to eject ink supplied from the ink discharge portion via the first connecting portion.

Further features of the present disclosure will become apparent from the following description of embodiments with reference to the attached drawings. The following description of embodiments are described by way of example.

### BRIEF DESCRIPTION OF THE DRAWINGS

FIG. 1 is a perspective view of an internal configuration of an essential part of a recording apparatus in a first embodiment.

FIGS. 2A to 2C are views of the configuration of an ink storage container in the first embodiment.

FIGS. 3A and 3B are views of the configuration of an ink supply portion of the ink storage container in the first embodiment.

FIGS. 4A and 4B are views of the configuration of an air communication portion of the ink storage container in the first embodiment.

FIG. 5 is a view of the connection between the ink storage container and the recording apparatus in the first embodiment.

FIGS. 6A and 6B are views for illustrating how air is supplied to the ink storage container in the first embodiment;

FIGS. 7A and 7B are views for illustrating how air between outer and inner bags is discharged in the first embodiment;

FIGS. 8A and 8B are views for illustrating how ink is supplied from the ink storage container in the first embodiment;

FIGS. 9A to 9C are views of the configuration of the ink storage container in a second embodiment;

FIGS. 10A and 10B are views of the configuration of the ink supply portion and the air communication portion in the second embodiment;

FIG. 11 is a view of the connection of the ink storage container and a recording apparatus in the second embodiment;

FIGS. 12A and 12B are views for illustrating a configuration of air supply and ink supply in the second embodiment; and

FIGS. 13A and 13B are views for illustrating how air between the outer and inner bags is discharged in a third embodiment.

### DESCRIPTION OF THE EMBODIMENTS

Hereinafter, modes for carrying out the present disclosure will be described in detail on the basis of embodiments in conjunction with the accompanying drawings. It should be noted that the dimensions, materials, shapes, and relative arrangements of the components in the following description of embodiments are subject to modifications as appropriate depending on the configuration of the apparatus to which the disclosure is applied and various other conditions. Note that not all combinations of features of the embodiments described herein are essential to the solutions provided by the present disclosure. The components in the description of the embodiments are merely examples, and are not intended to limit the scope of the present disclosure.

### First Embodiment

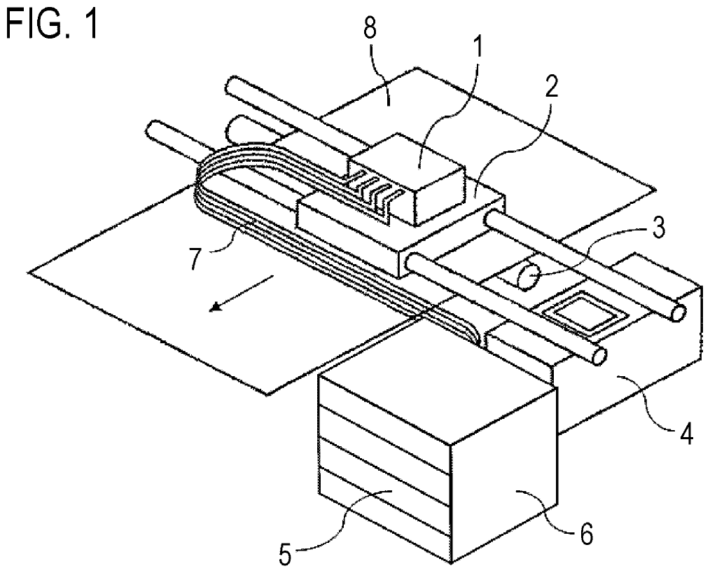

FIG. 1 is a perspective view of a configuration of a recording apparatus configured to serve as an ink ejection apparatus according to the embodiment. The recording apparatus shown in FIG. 1 repeatedly performs the reciprocating movement (main scanning) of a recording head 1 and the conveyance (sub-scanning) of a recording sheet 8, which serves as a recording medium, for each specified pitch. In synchronization with these movements, the recording apparatus selectively ejects ink droplets in a plurality of colors from the recording head 1 and lands the droplets on the recording sheet 8, which serves as the recording medium, thereby forming characters, symbols, images, and the like. Note that any recording medium may be used, provided that ink droplets can land thereon to form an image. For example, various materials and forms, such as paper, fabric, optical-disk label surfaces, plastic sheets, OHP sheets, and envelopes, may be used as recording media. Note that the liquid contained in the liquid storage container to which the present disclosure can be applied is typically ink, but is not limited thereto and may instead be a reaction liquid or a pretreatment liquid that is replenished to the liquid ejection apparatus.

As shown in FIG. 1, the recording head 1, which is a component of the main body, is slidably supported by two guide rails and detachably mounted on a carriage 2 that is driven by drive means such as a motor (not shown) to reciprocate in a straight line along the guide rails. The recording sheet 8, which receives ink ejected from the ink ejection portion of the recording head 1, is opposed to the ink ejection surface of the recording head 1 and is conveyed in a direction crossing the movement direction of the carriage 2 by a conveyance roller 3 which serves as a conveyance member. The recording head 1 has, as ink ejection portions, a plurality of nozzle arrays for ejecting ink in different colors. In accordance with the colors of the ink ejected from the recording head 1, a plurality of independent ink storage containers 5, each having an ink supply port, are detachably mounted on an ink supply unit 6. The ink supply unit 6 and the recording head 1 are connected to each other via a plurality of ink supply tubes 7, each corresponding to an ink color. By mounting the ink storage containers 5 on the ink supply unit 6, the ink in different colors stored in the ink storage containers 5 can be independently supplied to the respective nozzle arrays of the recording head 1. In a non-recording region located within the reciprocating range of the recording head 1 and outside of the conveyance path of the recording sheet 8, a recovery unit 4 is provided opposed to the ink ejection surface of the recording head 1. The recovery unit 4 includes a cap portion configured to cap the ink ejection surface of the recording head 1, a suction mechanism configured to forcibly suck ink in a state in which the ink ejection surface is capped, and a cleaning blade configured to wipe off stains from the ink ejection surface, among other components. The above-described suction operation is performed by the recovery unit 4 prior to the recording operation by the recording apparatus. As a result, even if the recording apparatus is operated after being left unused for a long period, the recovery unit 4 performs recovery processing to remove residual air bubbles from the ink ejection portion of the recording head 1 and thickened ink near the ejection openings. Thus, the ejection characteristics of the recording head 1 are maintained.

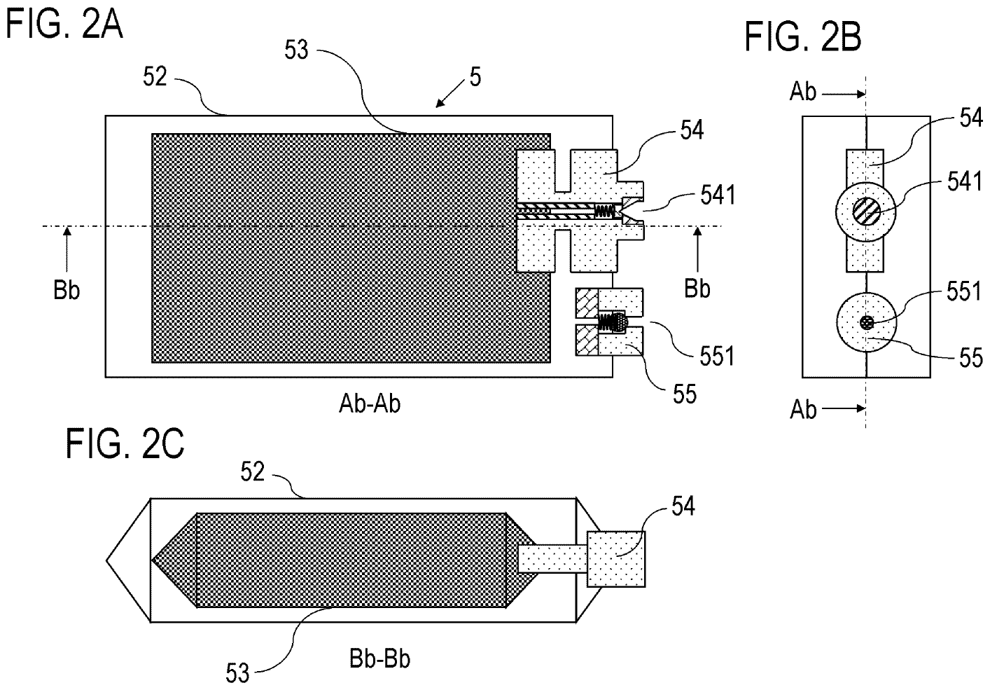

FIGS. 2A to 2C are views of the ink storage container 5 for each color housed in the ink supply unit 6 of the recording apparatus shown in FIG. 1 as a single unit, showing the configuration of the ink storage container in the first embodiment. FIG. 2A is a cross-sectional view taken along Ab-Ab of FIG. 2B. FIG. 2B is a view of the ink storage container 5 of the present embodiment as viewed from the side of a spout 54 as an ink discharge portion and the side of the air communication portion 55 as an air introduction portion, which will be described. FIG. 2C is a cross-sectional view taken along Bb-Bb FIG. 2A. As shown in FIG. 2A, the spout 54 and the air communication portion 55 are provided separately from each other on one end side in the longitudinal direction of the ink storage container 5. An inner bag 53 is welded and fixed to the spout 54. An outer bag 52 is fixed by welding to the spout 54 and the air communication portion 55. Ink 51 is injected into the inner bag 53, and air 10 (air) is sealed in a space between the inner bag 53 and the outer bag 52.

In Japanese Patent Application Publication No. 2011-183651, the outer container which covers the inner bag is made of a hard case of a material such as plastic, while in the first embodiment, the flexible outer bag 52 is used as the outer container to achieve so-called elimination or reduction of plastic waste, that is, a reduction in the amount of plastic used (and discarded). More specifically, in the present embodiment, both the inner bag 53 and the outer bag 52 are made of a flexible material (first material) that can deform in response to pressure from the ink. The spout 54, which allows the ink contained in the inner bag 53 to be discharged to the outside of the inner bag 53, and the air communication portion 55, which introduces air 10 into a space between the inner bag 53 and the outer bag 52, are made of a material (second material), such as plastic, that can maintain its shape against the pressure received from the ink. In Japanese Patent Application Publication No. 2011-183651, plastic is used in many parts, including the housing 12 which covers the ink bag 11 containing ink, and the ink outlet 13. Meanwhile, in the present embodiment, the outer bag 52 which covers the inner bag 53 is made of a flexible material, thereby reducing the amount of plastic used as compared with the conventional case. Stated differently, it can be considered that as for the ink storage container as a whole, only a first portion where the spout 54 is formed and a second portion where the air communication portion 55 is formed are made of the second material, and the remaining part is composed of the first material. More specifically, since the second material such as plastic is used only in the spout 54 and the air communication portion 55, the overall amount of plastic used in the ink storage container is reduced.

Ink (not shown) is stored in and fills the inner bag 53. The inner bag 53 is formed into a bag shape by performing heat-sealing or the like on a flexible film. Although the inner bag 53 may have various shapes, a pillow type, three-side seal type, or gusset type, which tends to become flat when the ink is used up, may be used. The flexible film has, on an inner side of the bag body that comes into contact with ink, a liquid-contact layer made of a thermoplastic resin, such as polyethylene, which has good wettability with ink and excellent heat-weldability, and, on an outer side of the bag body that comes into contact with air 10, a gas barrier layer having low gas permeability and formed by laminating multiple layers including an aluminum layer. Here, the aluminum layer is laminated as a film by vapor deposition or lamination. The film is not necessarily required to be of a multilayer type, and, for example, in applications where gas barrier properties are not critical, a single resin layer type may be used.

The outer bag 52 may have the same structure. Although the outer bag 52 is not always in contact with ink, the bag may have wettability with ink in case ink leaks from the inner bag 53.

As described above, the outer bag 52 and the inner bag 53 may be made of the same material. However, in order to reinforce the outer bag 52, which may be subject to significant external force such as impact upon dropping during conveyance, it is also effective to select, as the material of the outer bag 52, a more rigid and durable material than that of the inner bag 53 (for example, by increasing the number of laminated aluminum layers).

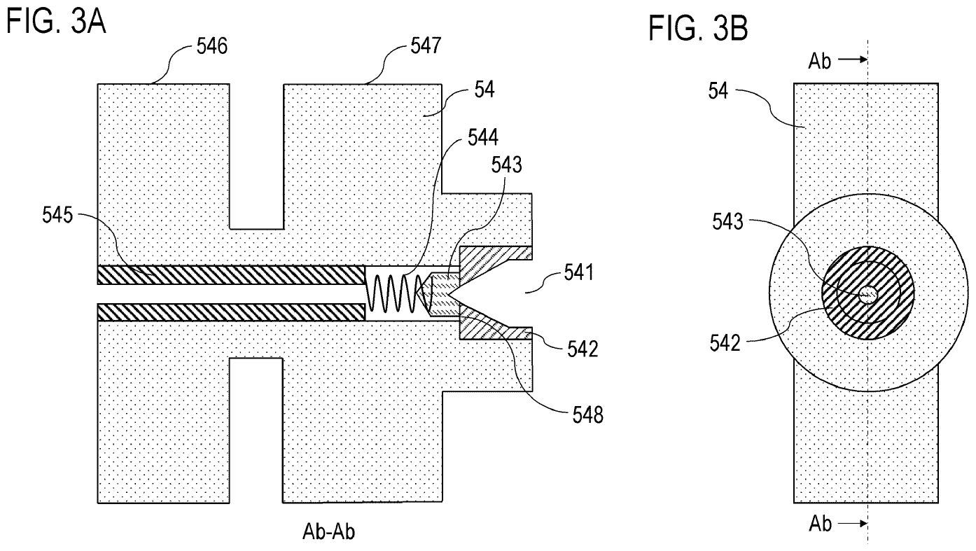

FIGS. 3A and 3B are enlarged views of the spout 54 in FIGS. 2A to 2C, showing a detailed structure of the spout 54. FIG. 3A is a cross-sectional view taken along line Ab-Ab of FIG. 3B. FIG. 3B is a view of the spout 54 as viewed from the side of an ink outlet 541. An ink outlet member 542 is provided in the spout 54 which serves as an ink supply portion (ink discharge portion), to form the ink outlet 541 (ink discharge port). A valve 543, serving as a first sealing member, is provided inside of the spout 54. The valve 543 can take a first sealing position in which the valve 543 comes into contact with a wall surface 548 of the ink outlet member 542 to close the ink outlet 541 from the inner side, and a first non-sealing position in which the valve 543 is away from the wall surface 548. As shown in FIG. 3A, the valve 543 is in close contact with the rear surface (wall surface) 548, thereby sealing the ink outlet 541. Furthermore, a biasing force is applied to the valve 543 by using a coil spring 544 or the like serving as a first biasing member so that the valve 543 can be brought into close contact with the wall surface of the ink outlet member 542 in the first sealing position. The coil spring 544 is fixed to a coil spring fixing member 545. The coil spring fixing member 545 defines a part of an ink discharge path that communicates between the inside of the inner bag 53 and the ink outlet 541. Therefore, the inner wall surface of the spout 54, the ink outlet member 542, and the coil spring fixing member 545 serve as a discharge path forming member for forming the ink discharge path.

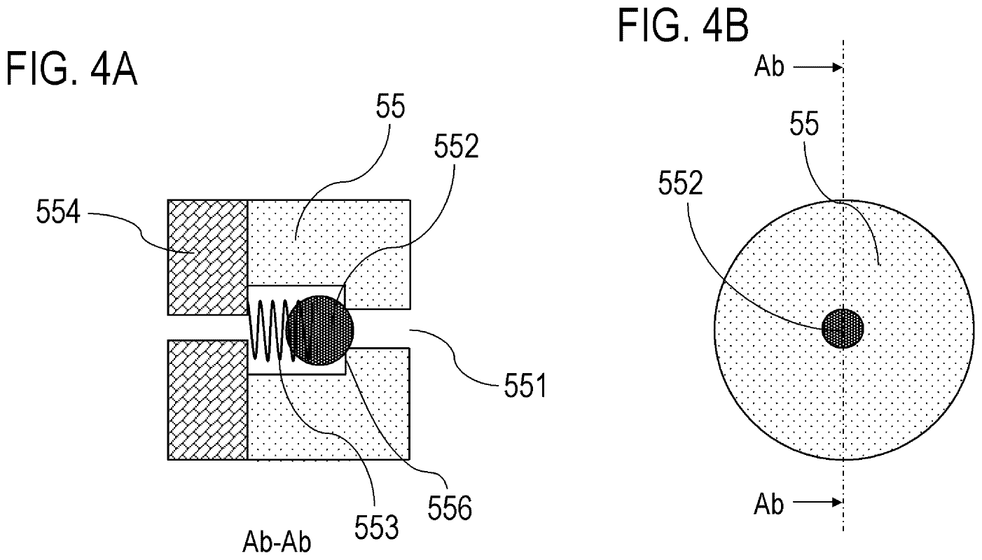

FIGS. 4A and 4B are enlarged views of the air communication portion 55 in FIGS. 2A to 2C, showing a detailed structure of the air communication portion 55. FIG. 4A is a cross-sectional view taken along line Ab-Ab of FIG. 4B. FIG. 4B is a view of the air communication portion 55 as viewed from the side of an air communication port 551. The air communication port 551 (air introduction port) is formed in the air communication portion 55 as an air introduction portion, and a wall surface 556 is provided inside of the air communication portion 55, which forms an air introduction path configured to introduce air from the air communication port 551, together with the coil spring fixing member 554, which will be described. Inside of the air communication portion 55, a valve 552 as a second sealing member is provided which is configured to take a second sealing position in contact with the wall surface 556 so as to close the air communication port from the inside and a second non-sealing position away from the wall surface 556. As shown in FIG. 4A, the valve 552 is in close contact with the rear surface (wall surface) 556 to close the air communication port 551. Furthermore, the coil spring 553 or the like as the second biasing member is used to apply a biasing force to the valve 552 so that the valve 552 can be in close contact with the wall surface 556 to close the air communication port 551. The coil spring 553 is fixed to the coil spring fixing member 554. The coil spring fixing member 554 defines a part of the air introduction path that communicates between a space between the inner bag 53 and the outer bag 52 and the air communication port 551. Therefore, the coil spring fixing member 554 and the wall surface 556 of the air communication portion 55 function as an introduction path forming member for forming the air introduction path.

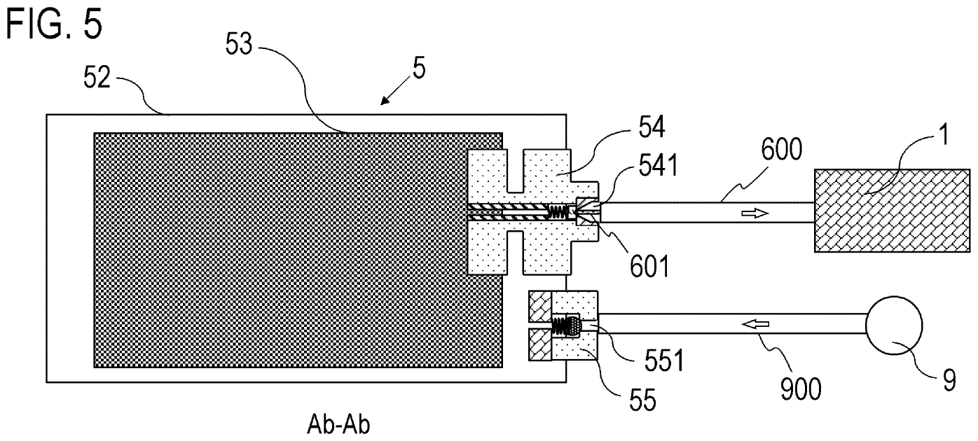

In FIG. 5, the recording head 1 (the recording apparatus main body) and a pressurization/suction mechanism 9 are connected to the ink storage container 5 of the first embodiment. As described above, the ink outlet 541 for supplying ink in the inner bag 53 to the recording head 1 is formed in the spout 54, and a hollow needle 601 provided in a first connecting portion 600 is inserted into the ink outlet 541. A pressurization/suction mechanism 9, serving as a pressurizing/suction means, is connected to the air communication port 551 via a second connecting portion 900 in order to supply air to or discharge air from the space between the inner bag 53 and the outer bag 52 through the air communication port 551 of the air communication portion 55. A pump or the like may be used as the pressurization/suction mechanism 9, but the mechanism is not limited thereto, and any device capable of performing pressurization and suction of air may be used. For example, a fan in the recording apparatus or a manual pump by a user may be used.

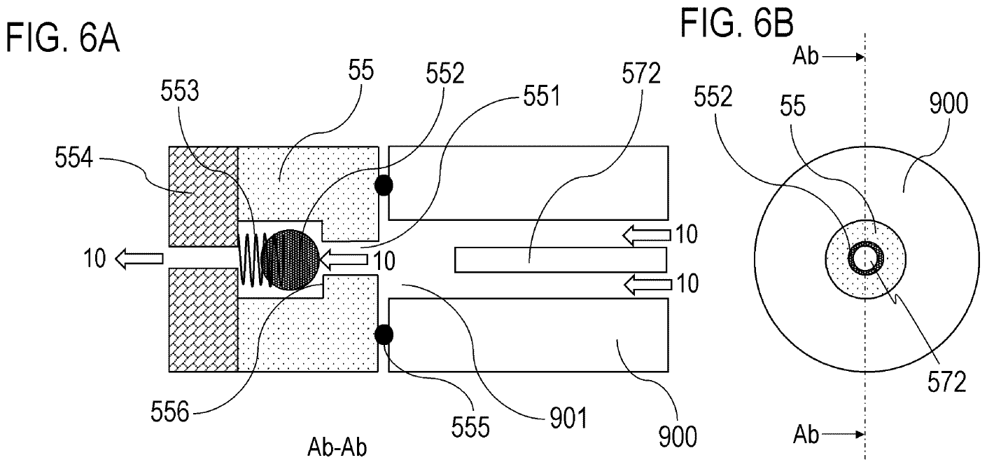

FIGS. 6A and 6B are views of a mechanism for allowing air 10 to flow between the inner bag 53 and the outer bag 52 from the pressurization/suction mechanism 9 shown in FIG. 5. FIG. 6A is a cross-sectional view taken along line Ab-Ab of FIG. 6B. FIG. 6B is a view of the configuration for allowing air 10 to flow in, as seen from the direction in which the air flows. The air communication portion 55, which is a part of the introduction path forming member, is configured to be connectable to the second connecting portion 900, and when the air 10 is made to flow in, the second connecting portion 900 connected to the pressurization/suction mechanism 9 is connected to the air communication portion 55. Then, the air 10 is sent from an air supply port 901 to pressurize the valve 552. At the time, the pressurizing force of the air 10 is greater than the biasing force of the coil spring 553. Therefore, the valve 552 is pressed by pressurization by the air 10 to move from the second sealing position where the valve closes the air communication port 551 to the second non-sealing position, so that the air communication port 551 is opened, and the air 10 can be introduced into the space between the inner bag 53 and the outer bag 52. When the pressurization by air stops, the valve 552 comes into close contact with the wall surface 556 again by the biasing force of the coil spring 553, and the air communication port 551 is sealed.

It should be noted that an air communication port sealing member 555 may be provided to reduce the likelihood of the air 10 leaking from the air communication port 551 during pressurization by the air 10.

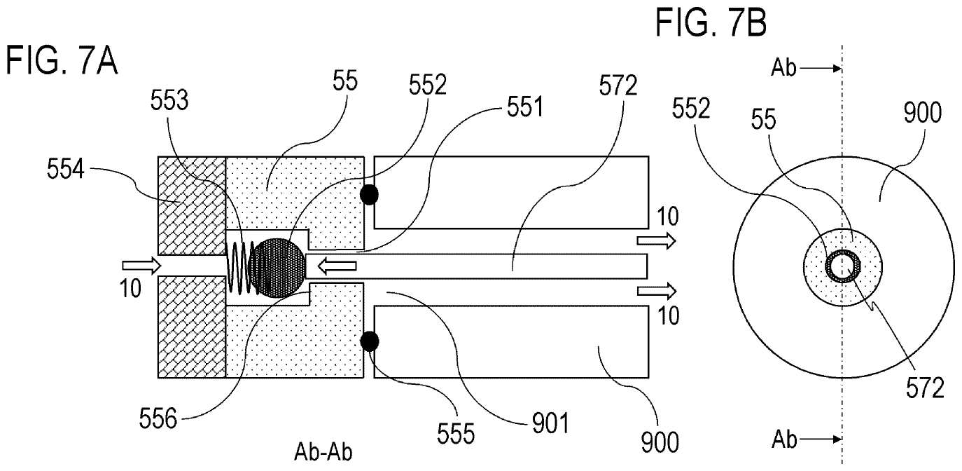

FIGS. 7A and 7B are views for illustrating the configuration for allowing the air 10 to be discharged from the space between the inner bag 53 and the outer bag 52 using the pressurization/suction mechanism 9 shown in FIG. 5. FIG. 7A is a cross-sectional view taken along line Ab-Ab of FIG. 7B. FIG. 7B is a view of the configuration for allowing the air 10 to be discharged as viewed from the air discharging direction. According to the embodiment, an atmosphere release pin 572 is provided inside of the second connecting portion 900 which can be connected to the air communication portion 55. The atmosphere release pin 572 is projected toward the valve 552, and the atmosphere release pin 572 is brought into contact with the valve 552. When the atmosphere release pin 572 is further projected to press the valve 552, the valve 552, which has been biased by the coil spring 553, moves away from the wall surface 556 and moves to the second non-sealing position from the second sealing position. In this way, the air communication portion 55 and the inside of the second connecting portion 900 communicate with each other via the air communication port 551, and the air 10 between the inner bag 53 and the outer bag 52 can be discharged.

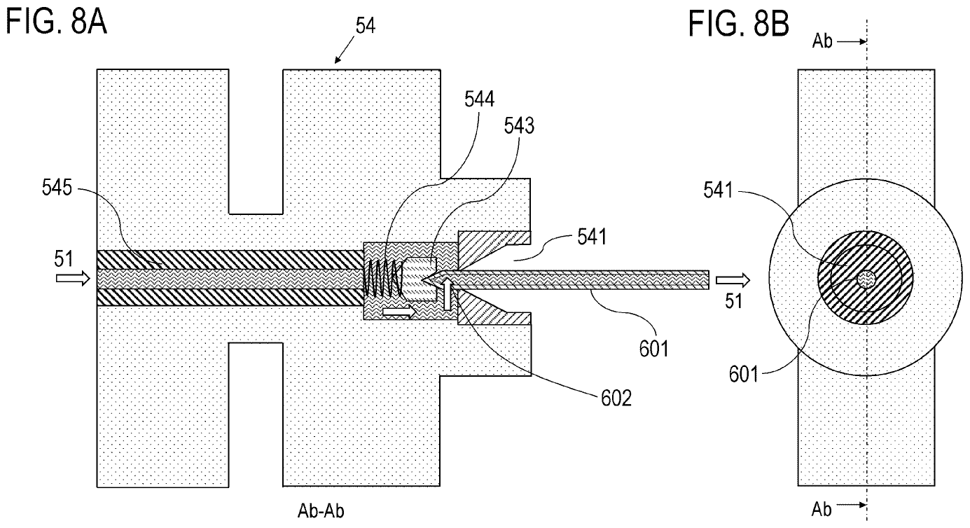

FIGS. 8A and 8B illustrate a configuration for allowing ink 51 to be supplied from the spout 54 to the recording head 1 (the recording apparatus main body) in FIG. 5. FIG. 8A is a cross-sectional view taken along line Ab-Ab of FIG. 8B. FIG. 8B is a view of the spout 54 as viewed from the ink outlet 541. The ink outlet 541 is configured to allow a hollow needle 601 provided on the first connecting portion 600 to be inserted therein. The hollow needle 601 is hollow inside and forms an ink flow path. Furthermore, an ink introduction port 602 for introducing ink 51 into the flow path is formed on the tip end side of the hollow needle 601. When the ink 51 is supplied from the inside of the inner bag 53, the hollow needle 601 is inserted into the ink outlet 541. Then, the tip end of the hollow needle 601 presses the valve 543, and the valve 543, which has been biased by the coil spring 544, moves from the first sealing position where the valve closes the ink outlet to the first non-sealing position. As a result, the ink discharge path inside of the coil spring fixing member 545 communicates with the flow path inside of the hollow needle 601, and the ink 51 can be supplied to the recording head 1.

With the above-described configuration for allowing the air 10 to flow in and the ink 51 to be supplied to the recording head 1, the inner bag 53 is pressurized by the air 10, and the ink 51 is supplied to the recording head 1 via the ink outlet 541.

As described above, in the first embodiment, the use of the flexible outer bag 52 instead of a hard plastic case or the like as the outer container that covers the inner bag 53 allows for elimination or reduction of plastic waste and a reduction in the overall amount of plastic used.

### Second Embodiment

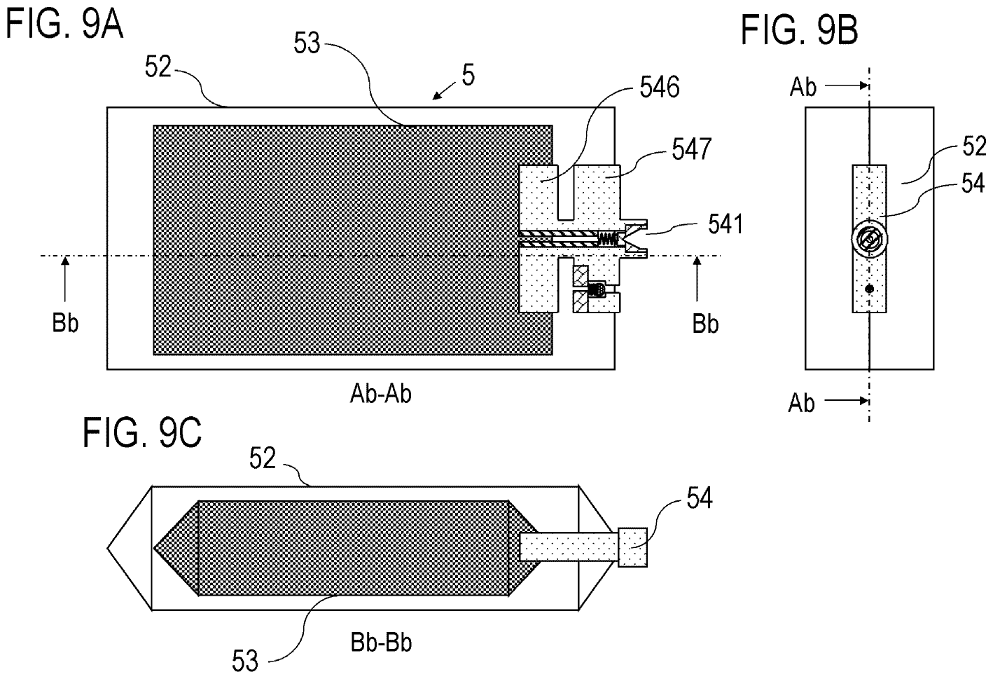

FIGS. 9A and 9B are views of an ink storage container 5 in a second embodiment. FIG. 9A is a cross-sectional view taken along line Ab-Ab of FIG. 9B. FIG. 9B is a view of the ink storage container 5 as viewed from the side of the spout 54. FIG. 9C is a cross-sectional view taken along line Bb-Bb of FIG. 9A. While the spout 54 and the air communication portion 55 are provided separately from each other in the first embodiment, in the ink storage container 5 of the present embodiment, the spout 54 as the ink supply portion (ink discharge portion) and the air communication portion which serve are integrally provided. In this way, by integrally forming the ink supply portion and the air communication portion, it becomes possible to further reduce the amount of plastic used.

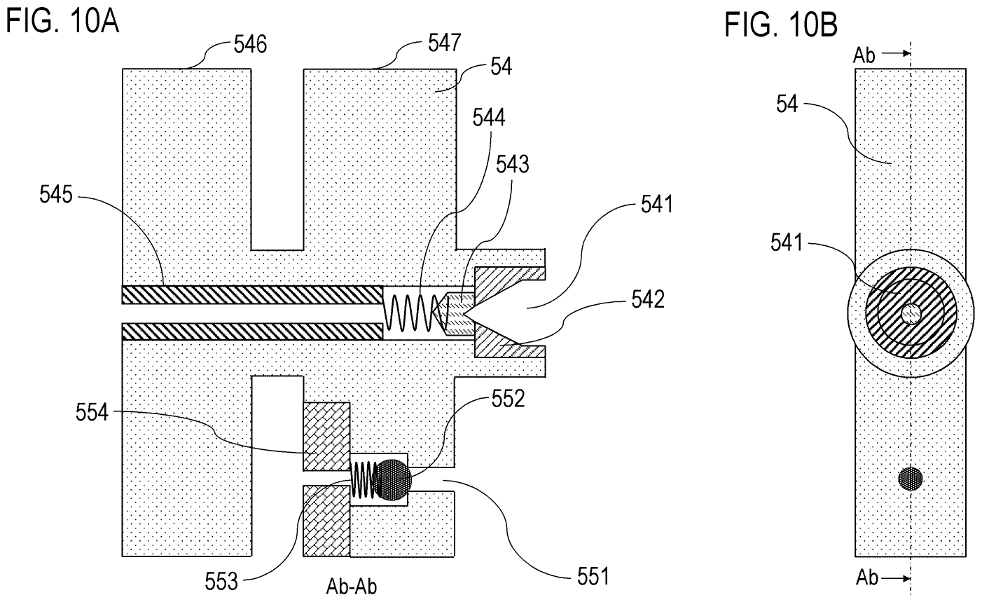

FIGS. 10A and 10B are views showing in detail the integral structure of the spout 54 as the ink supply portion and the air communication portion in FIGS. 9A to 9C. FIG. 10A is a cross-sectional view taken along line Ab-Ab of FIG. 10B. FIG. 10B is a view of the spout 54 as viewed from the side of the ink outlet 541. Since the sealing structure of the ink outlet 541 and the air communication port 551 is the same as that in the first embodiment, the description thereof will not be provided. In the present embodiment, the spout 54 and the air communication portion are integrated, so that the discharge path forming member forming the ink discharge path and the introduction path forming member forming the air introduction path are also composed of an integral member.

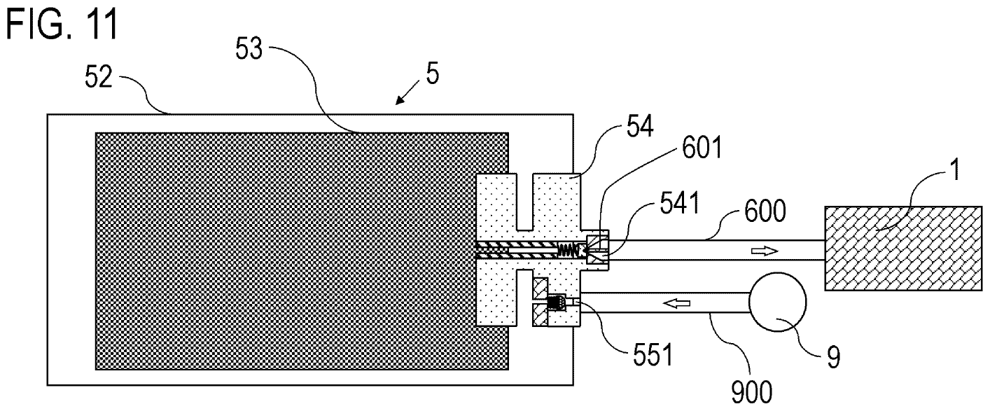

FIG. 11 is a cross-sectional view illustrating the connection state of the ink storage container 5 and the recording head 1 (the recording apparatus main body) in the second embodiment. Similarly to the first embodiment, the spout 54 is provided with the ink outlet 541 for supplying the ink in the inner bag 53 to the recording head 1, and a hollow needle 601 provided in the first connecting portion 600 is inserted into the ink outlet 541. A pressurization/suction mechanism 9 is provided which can supply air to a space between the inner bag 53 and the outer bag 52 via the air communication port 551.

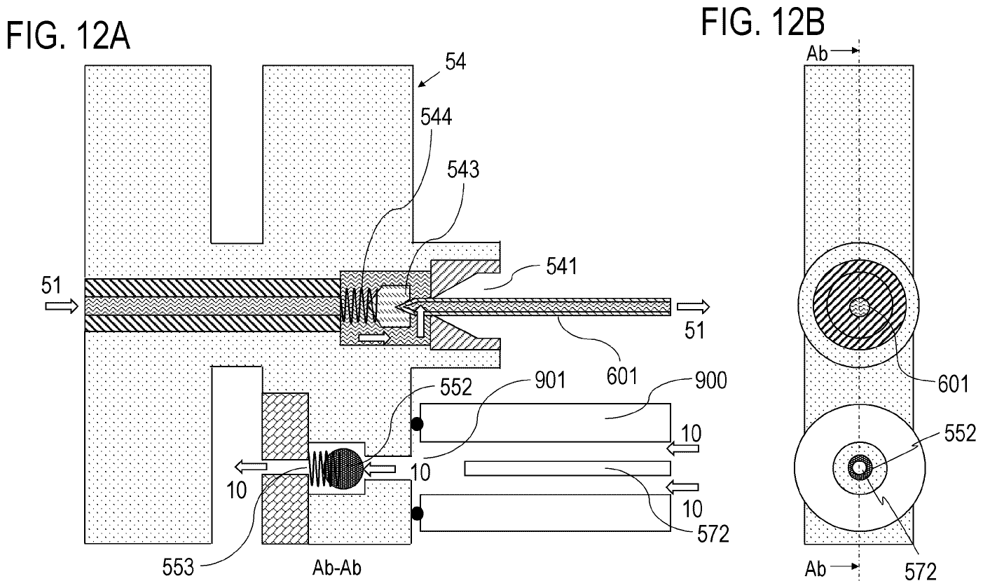

FIGS. 12A and 12B is a view showing in detail the configuration in which the ink 51 is supplied from the ink storage container 5 of FIGS. 10A and 10B to the recording head 1 and the configuration in which the air 10 is supplied from the pressurization/suction mechanism 9 between the inner bag 53 and the outer bag 52 to pressurize the inner bag 53. FIG. 12A is a cross-sectional view taken along line Ab-Ab of FIG. 12B. FIG. 12B is a view as viewed from the side of the ink outlet 541.

Similarly to the first embodiment, the hollow needle 601 provided on the first connecting portion 600 is inserted into the ink outlet 541 and the valve 543 is pushed, so that the valve 543, which has been biased by the coil spring 544, is moved. As a result, the ink discharge path and the flow path inside of the hollow needle 601 communicate with each other to supply the ink 51 to the recording head 1. Also, the mechanism for making the air 10 flow in is the same as the first embodiment, in which the second connecting portion 900 connected to the pressurization/suction mechanism 9 is connected to the air communication portion of the spout 54, and the air 10 is sent from the air supply port 901 to pressurize the valve 552. The pressurized valve 552 moves to open the air communication port 551 and supply air 10 to the space between the inner bag 53 and the outer bag 52.

With the above-described configuration for allowing the air 10 to flow in and the ink 51 to be supplied to the recording head 1, the ink 51 is supplied to the recording head 1 via the ink outlet 541 while the inner bag 53 is pressurized by the air 10.

Although the second embodiment is functionally the same as the first embodiment, the spout 54 and the air-communication portion are integrally formed, so that the amount of plastic used can be further reduced as compared with the first embodiment.

As shown in FIGS. 2A to 2C and FIGS. 9A to 9C, in the ink storage container 5 according to the present disclosure, the air 10 is introduced from the air communication port 551 during the manufacturing stage, and when the ink storage container 5 is viewed as a single ink storage container, the space between the inner bag 53 and the outer bag 52 is filled with the air 10. Since the space filled with the air 10 is sealed by the valve 552, the amount of air in the space can be kept constant. Therefore, even if a user who uses it accidentally applies an impact (drop or the like) after manufacturing and shipping in this state, the air filled in the space between the inner bag 53 and the outer bag 52 serves as a cushion material to prevent ink leakage. Furthermore, when ink is supplied to the recording head 1, the inner bag 53 is pressurized by the air 10, so that the amount of available ink can be increased, and the performance of using up ink can be improved.

### Third Embodiment

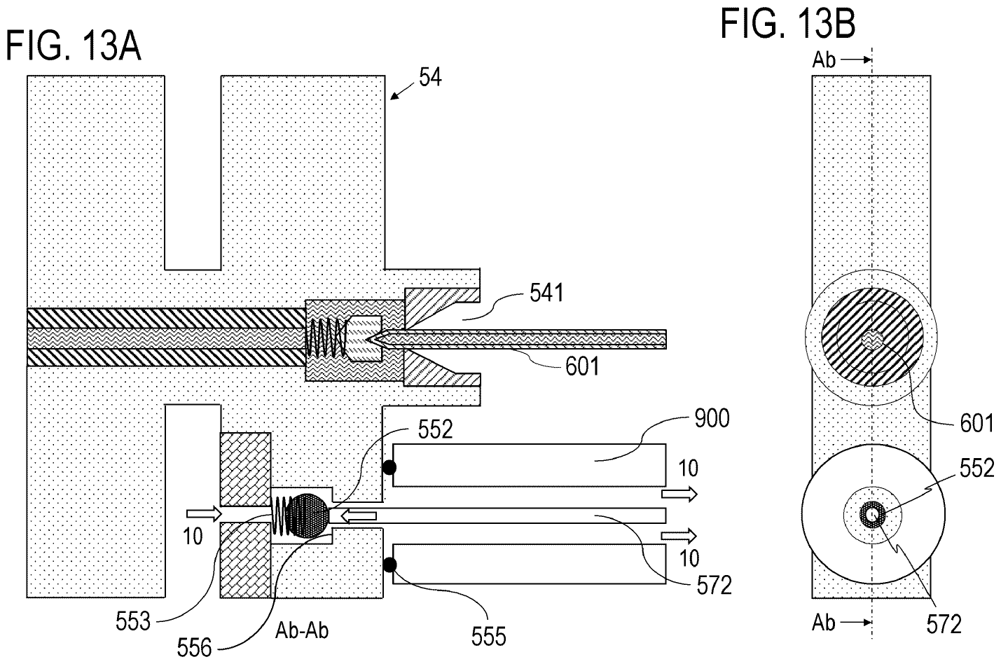

FIGS. 13A and 13B are views of the spout 54 in a third embodiment. FIG. 13A is a cross-sectional view taken along line Ab-Ab of FIG. 13B. FIG. 13B is a view of the spout 54 as viewed from the side of ink outlet 541. In the first and second embodiments, the inner bag 53 is pressurized to improve the complete use efficiency of ink. When the ink storage container 5 that has run out of ink is replaced with a replacement ink storage container 5 filled with ink and the used ink storage container 5 is removed as it is, the outer bag is in an inflated state due to the pressurized air. In this state, an unnecessary space is required for disposal or collection. In the third embodiment, the air 10 is discharged from the space between the outer bag 52 and the inner bag 53. The atmosphere release pin 572 is provided inside of the second connecting portion 900. When the atmosphere release pin 572 is projected toward the valve 552 of the air communication portion 55, the atmosphere release pin 572 comes into contact with the valve 552. When the pin is further projected, the coil spring 553 is pressed, and the valve 552 moves away from the wall surface 556 and moves to the second non-sealing position from the second sealing position where the valve closes the air communication port 551. In this state, the space between the outer bag 52 and the inner bag 53 communicates with the space outside of the ink storage container 5. The air enclosed in the outer bag 52 is discharged, and the entire ink storage container 5 attains a deflated state.

### Fourth Embodiment

In a fourth embodiment, a configuration (not shown) for positively discharging air is provided. In the fourth embodiment, similarly to the third embodiment, the valve 552 is pressed by the atmosphere release pin 572, so that the space between the outer bag 52 and the inner bag 53 communicates with the space outside of the ink storage container 5. In this state, the pump 9 which serves as a pressurization/suction mechanism performs a suction operation. This suction operation enables the air to be discharged quickly and reliably. Alternatively, the air may be discharged using a manual pump operated by the user. Furthermore, the air may also be discharged by removing the ink storage container 5 and inserting a toothpick or another similarly shaped object toward the valve 552.

As in the foregoing, the outer bag 52, which has conventionally been made of plastic, is formed of a flexible material, and the spout 54 and the air communication portion, which have also been conventionally made of plastic, are integrally formed. With the configuration, the amount of plastic used can be reduced. In other words, the technologies described in this specification have the potential to contribute to the achievement of a sustainable society, such as a decarbonized society/circular society.

According to the present disclosure, a highly reliable ink storage container can be provided while achieving a reduction in the amount of plastic used.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Applications No. 2024-078843, filed on May 14, 2024, and No. 2025-034081, filed on Mar. 4, 2025, which are hereby incorporated by reference herein in their entirety.

What is claimed is:

1. An ink storage container detachably mounted to an apparatus main body of an ink ejection apparatus, the ink storage container comprising:
a flexible inner bag configured to store ink;
a flexible outer bag configured to cover the inner bag;
an ink discharge portion configured to allow ink stored in the inner bag to be discharged to the outside of the inner bag; and
an air introduction portion configured to introduce air into a space between the inner bag and the outer bag; wherein
the ink discharge portion comprising:
a discharge path forming member having an ink outlet and an ink discharge path that communicates between an interior of the inner bag and the ink outlet;
a first sealing member configured to take a first sealing position and a first non-sealing position within the ink discharge path, the first sealing position being a position at which the first sealing member is in contact with a wall surface of the ink discharge path to seal the ink discharge outlet from an interior of the ink discharge path and the first non-sealing position being a position at which the first sealing member is away from the wall surface; and
a first biasing member configured to apply a biasing force to position the first sealing member at the first sealing position.

2. The ink storage container according to claim 1, wherein
the inner bag and the outer bag are composed of a first material deformable by pressure received from ink, and
the ink discharge portion and the air introduction portion are composed of a second material capable of maintaining its shape against pressure received from the ink.

3. The ink storage container according to claim 2, further comprising:
a first part made of the second material and having the ink discharge portion formed thereon; and
a second part made of the second material and having the air introduction portion formed thereon, wherein
the first portion and the second portion are provided separately from each other.

4. The ink storage container according to claim 3, wherein
the first part and the second part are provided on one end side in a longitudinal direction of the ink storage container.

5. The ink storage container according to claim 1, wherein
the ink discharge portion and the air introduction portion are integrally provided.

6. The ink storage container according to claim 1, wherein
the ink outlet is configured to allow insertion of a first connecting portion provided in the apparatus main body,
the first sealing member is pushed by the first connecting portion inserted into the ink outlet, and moves from the first sealing position to the first non-sealing position, and
the ink discharge path communicates with an ink introduction port provided at the first connecting portion that has pushed the first sealing member to the first non-sealing position.

7. The ink storage container according to claim 1, wherein
the air introduction portion comprises:
an introduction path forming member having an air introduction port and an air introduction path communicating between the space and the air introduction port;
a second sealing member configured to take a second sealing position and a second non-sealing position within the air introduction path, the second sealing position being a position at which the second sealing member is in contact with a wall surface of the air introduction path to seal the air introduction port from an inside of the air introduction path and the second non-sealing position being a position at which the second sealing member is away from the wall surface; and
a second biasing member configured to apply a biasing force to position the second sealing member in the second sealing position.

8. The ink storage container according to claim 7, wherein
the introduction path forming member is configured to allow connection to a second connecting portion provided in the apparatus main body,
the air introduction port is configured to be connectable to an air supply port of the second connecting portion connected to the introduction path formation member,
the second sealing member moves from the second sealing position to the second non-sealing position in response to a pressure caused by air supplied from the air supply port of the second connecting portion connected to the air introduction port exceeding a biasing force applied by the second biasing member, and
the air introduction path communicates with the air supply port of the second connecting portion when the second sealing member is in the second non-sealing position.

9. The ink storage container according to claim 7, wherein
the discharge path forming member and the introduction path forming member are formed as an integral member.

10. The ink storage container according to claim 2, wherein
the second material is plastic.

11. An ink ejection apparatus comprising:
the ink storage container according to claim 1; and
an apparatus main body to which the ink storage container is detachably mounted;
the apparatus main body comprising:
a first connecting portion connected to the ink discharge portion;
a second connecting portion connected to the air introduction portion; and
an ejection portion configured to eject ink supplied from the ink discharge portion via the first connecting portion.

12. The ink ejection apparatus according to claim 11, wherein
the apparatus main body has a mechanism that can perform pressurization to supply air to the second connecting portion and suction to draw air from the space.
